(19) United States
(12) Patent Application Publication
(10) Pub. No.: US 2025/0317912 A1
(43) Pub. Date: Oct. 9, 2025

(54) CROSS-LINK REQUEST TO SEND (RTS)-CLEAR TO SEND (CTS)

(71) Applicant: Ofinno, LLC, Reston, VA (US)

(72) Inventors: Leonardo Alisasis Lanante, Reston, VA (US); Jeongki Kim, Fairfax, VA (US); Esmael Hejazi Dinan, McLean, VA (US)

(73) Assignee: Ofinno, LLC, Reston, VA (US)

(21) Appl. No.: 19/240,355

(22) Filed: Jun. 17, 2025

Related U.S. Application Data
(63) Continuation of application No. PCT/US2023/084267, filed on Dec. 15, 2023.
(60) Provisional application No. 63/434,128, filed on Dec. 21, 2022.

(51) Int. Cl. H04W 72/0446; H04L 5/00

(52) U.S. Cl. CPC H04W 72/0446; H04L 5/0055

(57) ABSTRACT

A first station (STA) receives from a second STA, on a sub-7 GHz link, a cross-link Request to Send (XRTS) frame for reserving a mmWave link for transmission of a data frame by the second STA. In response to the XRTS frame, and based on the mmWave link being unavailable for transmission of the data frame by the second STA, first STA transmits to the second STA a response frame comprising one of: an acknowledgment of the XRTS frame; a denial to transmit on the mmWave link; or a grant of a service period (SP) on the mmWave link for transmission of the data frame by the second STA.

### CROSS-REFERENCE TO RELATED APPLICATIONS

This application is a continuation of International Application No. PCT/US2023/084267, filed Dec. 15, 2023, which claims the benefit of U.S. Provisional Application No. 63/434,128, filed Dec. 21, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example trigger frame.

FIG. 4 illustrates an example Common Info field.

FIG. 5 illustrates an example directional multi-gigabit (DMG) grant frame.

FIG. 6 illustrates an example DMG Denial to Send (DTS) frame.

FIG. 7 illustrates an example Request-to-Send (RTS)/Clear-to-Send (CTS) procedure.

FIG. 8 illustrates examples of transmission of Request to Send (RTS) and Clear to Send (CTS) frames in the mmWave band.

FIG. 9 is an example that illustrates an existing cross-link reservation procedure for the mmWave band.

FIG. 10 is an example that illustrates a potential problem that may occur using the existing procedure described in FIG. 9.

FIG. 11 is an example that illustrates a first procedure according to an embodiment.

FIG. 12 is another example that illustrates the first procedure according to an embodiment.

FIG. 13 is an example that illustrates a second procedure according to an embodiment.

FIG. 14 is an example that illustrates a third procedure according to an embodiment.

FIG. 15 is an example that illustrates a fourth procedure according to an embodiment.

FIG. 16 illustrates an example control frame which may be used as a cross-link RTS frame according to an embodiment.

FIG. 17 illustrates an example trigger frame which may be used as a cross-link RTS frame according to an embodiment.

FIG. 18 illustrates an example control frame which may be used as a cross-link CTS frame according to an embodiment.

FIG. 19 illustrates an example CTS frame which may be used as a cross-link CTS frame according to an embodiment.

FIG. 20 illustrates an example control frame which may be used as a cross-link DTS frame according to an embodiment.

FIG. 21 illustrates an example control frame which may be used as a cross-link grant frame according to an embodiment.

FIG. 22 illustrates an example DMG grant frame which may be used as a cross-link grant frame according to an embodiment.

FIG. 23 illustrates an example process according to an embodiment.

FIG. 24 illustrates another example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

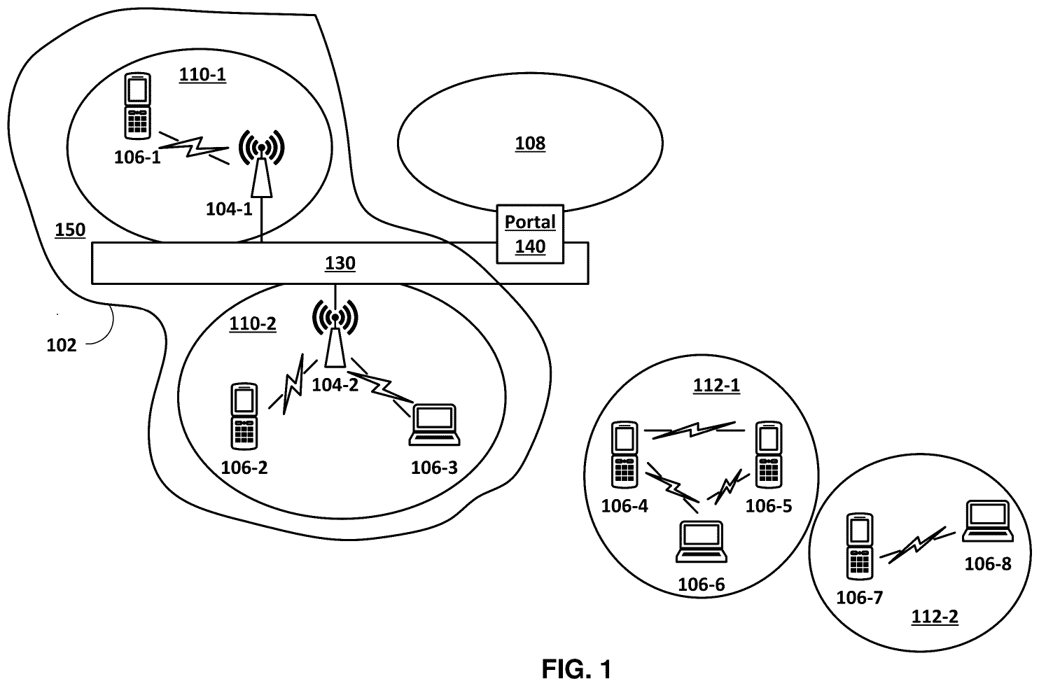

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHZ, 5 GHZ, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHZ, 80 MHZ, 160 MHz, or 320 MHz by bonding together multiple 20 MHz channels.

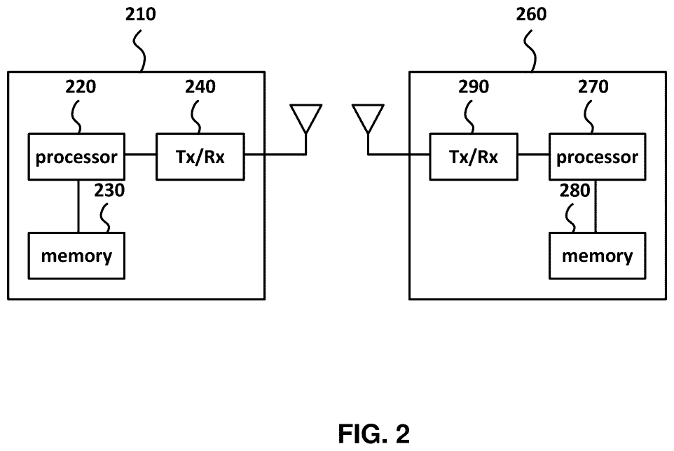

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

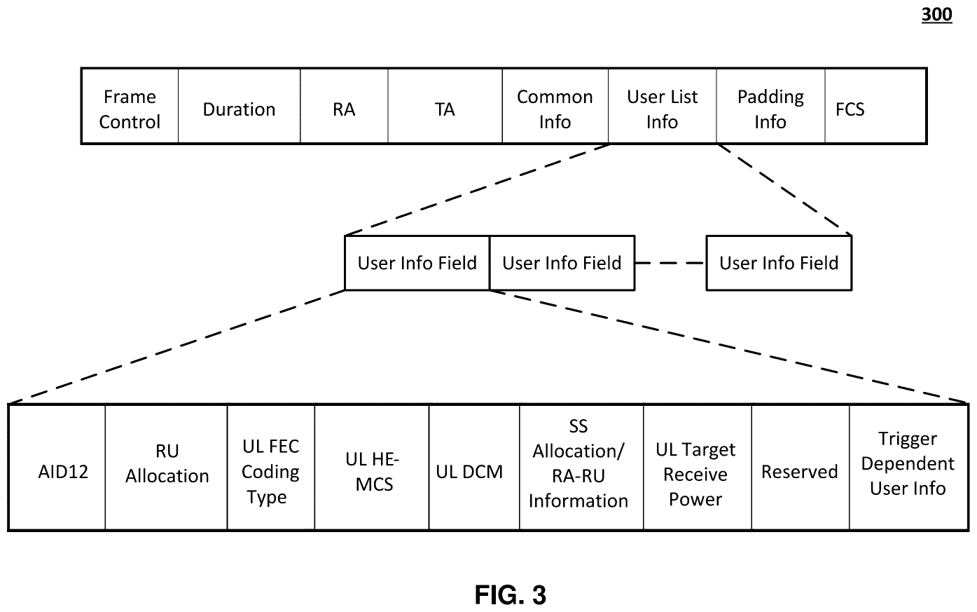

FIG. 3 illustrates an example trigger frame 300. Trigger frame 300 may correspond to a basic trigger frame as defined in the existing IEEE 802.11ax standard amendment. Trigger frame 300 may be used by an AP to allocate resources for and solicit one or more TB PPDU transmissions from one or more STAs. Trigger frame 300 may also carry other information required by a responding STA to transmit a TB PPDU to the AP.

As shown in FIG. 3, trigger frame 300 includes a Frame Control field, a Duration field, a receiver address (RA) field, a transmitter address (TA) field, a Common Info field, a User List Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 300 if trigger frame 300 is addressed to STAs that belong to a single BSS. The TA field is the transmitted BSSID if the trigger frame 300 is addressed to STAs from at least two different BSSs of the multiple BSSID set.

The Common Info field specifies a trigger frame type of trigger frame 300, a transmit power of trigger frame 300 in dBm, and several key parameters of a TB PPDU that is transmitted by a STA in response to trigger frame 300. The trigger frame type of a trigger frame used by an AP to receive QoS data using UL MU operation is referred to as a basic trigger frame.

The User List Info field contains a User Info field per STA addressed in trigger frame 300. The per STA User Info field includes, among others, an AID subfield, an RU Allocation subfield, a Spatial Stream (SS) Allocation subfield, an MCS subfield to be used by a STA in a TB PPDU transmitted in response to trigger frame 300, and a Trigger Dependent User Info subfield. The Trigger Dependent User Info subfield can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 300 to extend the frame length to give recipient STAs enough time to prepare a response for transmission one SIFS (short interframe spacing) after the frame is received. The Padding field, if present, is at least two octets in length and is set to all 1s.

The FCS field is used by a STA to validate a received frame and to interpret certain fields from the MAC headers of a frame.

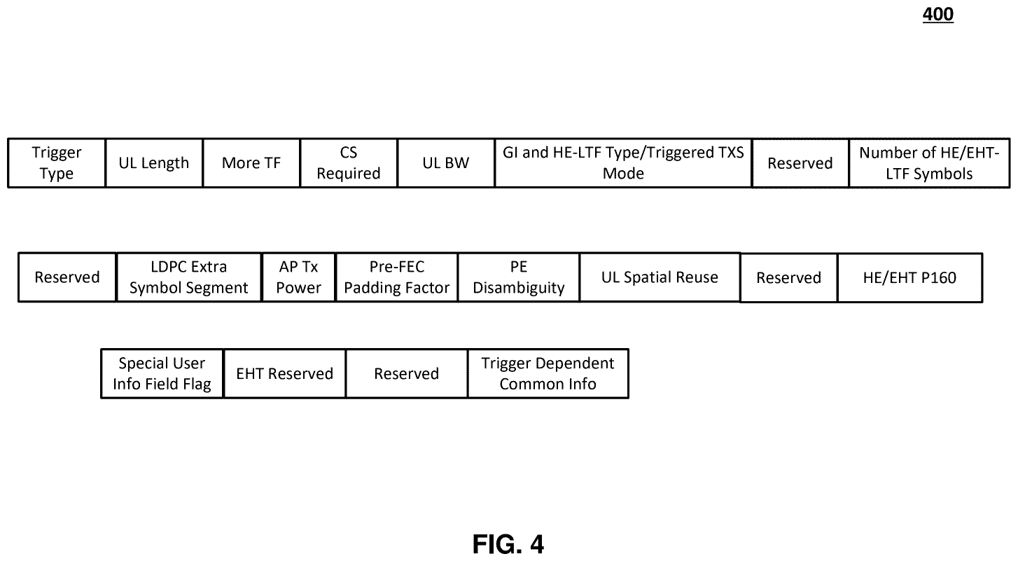

FIG. 4 illustrates an example Common Info field 400. Common Info field 400 may be an embodiment of the Common Info field of trigger frame 300 for example. As shown in FIG. 4, Common Info field 400 may include a Trigger Type subfield, a UL Length subfield, a More TF subfield, a CS required subfield, a UL BW subfield, a GI and HE-LTF Type/Triggered TXS Mode subfield, a first Reserved subfield, a Number of HE/EHT-LTF Symbols subfield, a second Reserved subfield, an LDPC Extra Symbol Segment subfield, an AP Tx Power subfield, a Pre-FEC Padding Factor subfield, a PE Disambiguity subfield, an UL Spatial Reuse subfield, a third Reserved subfield, an HE/EHT P160 subfield, a Special User Info Field Flag subfield, an EHT Reserved subfield, a fourth Reserved subfield, and a Trigger Dependent Common Info subfield. The Trigger Type subfield, UL Length subfield, More TF subfield, CS required subfield, UL BW subfield, GI and HE-LTF Type/Triggered TXS Mode subfield, first Reserved subfield, Number of HE/EHT-LTF Symbols subfield, second Reserved subfield, LDPC Extra Symbol Segment subfield, AP Tx Power subfield, Pre-FEC Padding Factor subfield, PE Disambiguity subfield, UL Spatial Reuse subfield, third Reserved subfield, HE/EHT P160 subfield, Special User Info Field Flag subfield, EHT Reserved subfield, fourth Reserved subfield, and Trigger Dependent Common Info subfield may have the same content and interpretation as corresponding subfields of an EHT variant Common Info field defined in the IEEE 802.11be version 2.2 draft amendment.

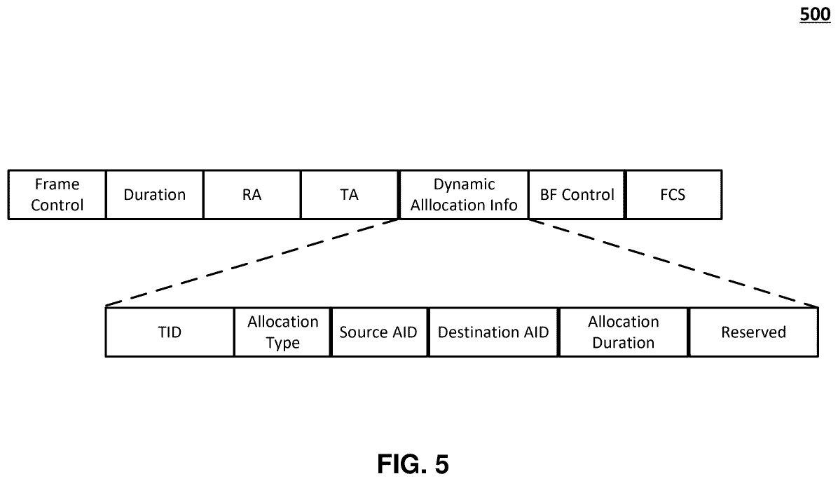

FIG. 5 illustrates an example grant frame 500. Grant frame 500 may have a format that corresponds to a grant frame format defined in section 9.3.1.12 of the IEEE 802.11 standard (“IEEE P802.11-REVme/D2.0, October 2022”). As shown in FIG. 5, grant frame 500 may include a Frame Control field, a Duration field, an RA field, a TA field, a Dynamic Allocation Info field, a BF Control field, and an FCS field.

For individually addressed grant frames: if the grant frame is used to obtain a transmission opportunity (TXOP), the Duration field is set to a value subject to the TXOP limit as described in 10.23.2.9 (TXOP limits) of the IEEE 802.11 standard. In all other cases within a contention-based access period (CBAP), the Duration field is set to the Duration field of the immediately preceding frame minus TXTIME (Grant frame) minus a SIFS Time. If the grant frame is sent within a service period (SP), the Duration field is set according to the rules in sections 10.39.7 (Dynamic allocation of service period), 10.39.8 (Dynamic truncation of service period), and 10.39.9 (Dynamic extension of service period) as appropriate depending on the grant frame usage. If the grant frame is sent within an announcement transmission interval (ATI), the Duration field is set according to the rules in 10.39.3 (ATI transmission rules).

For group addressed grant frames, the Duration field is set to the time between PHY-TXEND.indication primitive of the grant frame and the start of the allocation as indicated by the Allocation Duration subfield within the Dynamic Allocation Info field.

The RA field contains the MAC address of the STA receiving the SP grant. The TA field contains the MAC address of the STA that has transmitted the grant frame.

The Dynamic Allocation Info field is defined in section 9.5.2 (Dynamic Allocation Info field) of the IEEE 802.11 standard. As shown, the Dynamic Allocation Info field includes a TID subfield, an Allocation Type subfield, a source AID subfield, a Destination AID subfield, an Allocation Duration subfield, and a Reserved subfield.

The TID subfield identifies the traffic category (TC) or traffic stream (TS) for the allocation request or grant. The Allocation Type subfield is defined in section 9.4.2.131 (Extended Schedule element). The Source AID subfield identifies the STA that is the source of the allocation. The Destination AID subfield identifies the STA that is the destination of the allocation.

When the Dynamic Allocation Info field is transmitted within a service period request (SPR) frame, the Allocation Duration subfield contains the requested duration in microseconds. When the Dynamic Allocation Info subfield is transmitted within a Grant frame by an AP or PCP (personal basic service set (PBSS) control point) in an ATI or grant period (GP), the Allocation Duration subfield contains the granted duration of the SP or CBAP allocation in microseconds (see sections 10.39.3 (ATI transmission rules), 10.39.7 (Dynamic allocation of service period), 10.39.8 (Dynamic truncation of service period), and 10.39.9 (Dynamic extension of service period)). Possible values range from 0 to 32767 for an SP allocation and a CBAP allocation. Setting the Allocation Duration subfield transmitted to 0 within a grant frame means that the STA can transmit one PPDU followed by any relevant acknowledgment plus one RTS/DMG CTS handshake.

When the Dynamic Allocation Info subfield is transmitted within a Grant frame in a CBAP, the value of the Allocation Duration field indicates the purpose of the Grant frame transmission. Two purposes are possible: a) Beyond current TXOP: in this case, the Allocation Duration subfield values range from 0 to 32767.

The value of the Allocation Duration field plus the Duration field of the grant frame indicates the time offset from the PHY-TXEND.indication primitive of the grant frame when the STA transmitting the grant frame will attempt to initiate access for communication with the STA indicated by the RA field of the grant frame. b) Within current TXOP: in this case, the Allocation Duration subfield is set to 32768. When the Dynamic Allocation Info subfield is transmitted within a grant frame with RA set to broadcast address by a source or destination STA of an SP, the Allocation Duration subfield values range from 0 to 32767.

When the Dynamic Allocation Info subfield is transmitted within a grant frame with the RA set to an individual address by a source STA of an SP, the Allocation Duration subfield is set to 32768.

The BF Control field is defined in section 9.5.5 (Beamforming Control field) of the IEEE 802.11 standard.

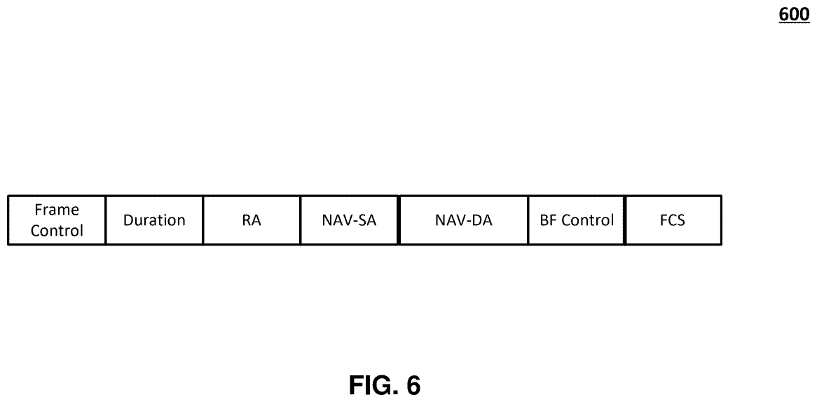

FIG. 6 illustrates an example DMG Denial to Send (DTS) frame 600. DMG DTS frame 600 may have a format that corresponds to a DMG DTS frame format defined in section 9.3.1.14 of the IEEE 802.11 standard (“IEEE P802.11-REVme/D2.0, October 2022”). As shown in FIG. 6, DMG DTS frame 600 may include a Frame Control field, a Duration field, an RA field, a NAV-SA field, a NAV-DA field, and an FCS field.

The Duration field is set to the value of the NAV of the transmitting STA-(TXTIME (DMG DTS)+SIFS) or the remaining time in the SP at the end of the DMG DTS frame transmission, whichever is smaller. The transmitting STA's NAV is the value of its NAV at the start of the DMG DTS frame transmission.

The RA field of the frame is copied from the TA field of the immediately previous RTS frame to which the DMG DTS frame is a response.

The NAV-SA and the NAV-DA fields contain the MAC addresses of the source DMG STA and the destination DMG STA, respectively, whose exchange of an RTS and DMG CTS frame caused the last update to the NAV at the transmitting STA.

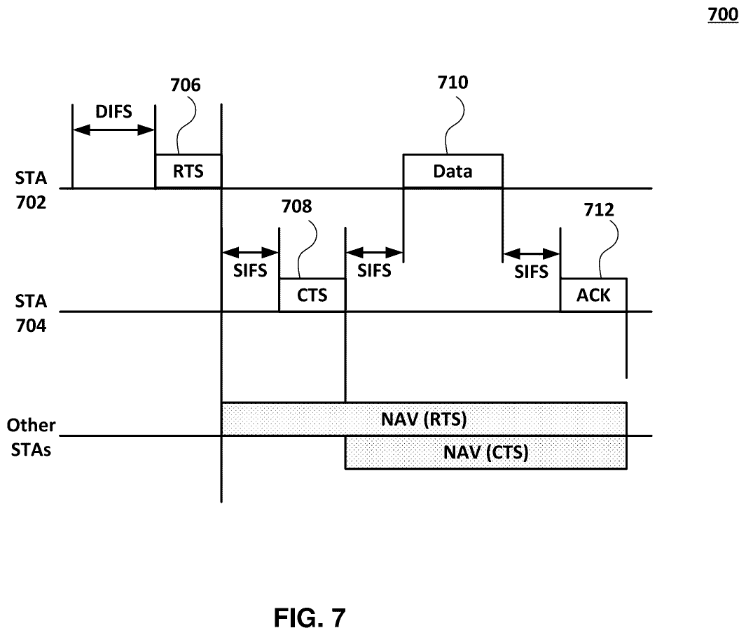

FIG. 7 illustrates an example 700 of a Request-to-Send (RTS)/Clear-to-Send (CTS) procedure. Example RTS/CTS procedure 700 may be an example according to the RTS/CTS procedure as defined in section 10.3.2.9 of the IEEE 802.11 standard draft “IEEE P802.11-REVme™/D1.3, June 2022.” As shown in FIG. 7, example RTS/CTS procedure 700 may include STAs 702 and 704. Other STAs of the same BSS may also be within communication range of STAs 702 and 704.

In an example, STA 702 may transmit an RTS frame 706 to STA 704. STA 702 may transmit RTS frame 706 to protect from hidden STA(s) the transmission of a data frame 710 that STA 702 intends to transmit. RTS frame 706 may include a Duration/ID field. The Duration/ID field may be set to the time, in microseconds, required to transmit data frame 710, plus one CTS frame, plus one ACK frame (if required), plus three SIFS (Short Interframe Spacing) periods.

In an example, STA 704 may respond to RTS frame 706 by transmitting a CTS frame 708 to STA 702. CTS frame 708 may be transmitted one SIFS period after RTS frame 706. STA 704 may respond to RTS frame 706 when RTS frame 706 is addressed to STA 704 and after considering the NAV, unless the NAV was set by a frame originating from STA 702. STA 704 may respond to the RTS frame 706 when RTS frame 706 is addressed to STA 704 and if the NAV indicates idle. For a non-S1G STA, the NAV indicates idle when the NAV count is 0 or when the NAV count is non-zero but a nonbandwidth signaling TA obtained from a TA field of RTS frame 706 matches a saved TXOP holder address. For an S1G STA, the NAV indicates idle when both the NAV and RID (response indication deferral) counters are 0 or when either the NAV or RID counter is non-zero but the TA field of RTS frame 706 matches the saved TXOP holder address.

STA 704 may set an RA field of CTS frame 708 to a nonbandwidth signaling TA obtained from the TA field of RTS frame 706. STA 704 may set a Duration field of CTS frame 708 based on the Duration/ID field of RTS frame 706, namely as equal to the value of the Duration/ID field of RTS frame 706, adjusted by subtracting the time required to transmit CTS frame 708 and one SIFS period.

Upon receiving CTS frame 708, STA 702 may wait one SIFS period before transmitting data frame 710. STA 704 may transmit an ACK frame 712 in response to data frame 710. STA 704 may transmit ACK frame 712 one SIFS after receiving data frame 710.

As shown in example 700, other STAs within communication range of STAs 702 and 704, and belonging to the same BSS, may set their NAVs according to RTS frame 706 and/or CTS frame 708. For example, a STA receiving RTS frame 706 may set its NAV based on the Duration/ID field of RTS frame 706. Another STA receiving CTS frame 708 may set its NAV based on the Duration field of CTS frame 708. As such, the other STAs may not access the channel using EDCA until the end of transmission of ACK frame 712.

It is anticipated that future WLANs (e.g., Ultra High Reliability (UHR) WLAN) provide support for mmWave operation. Specifically, it expected that all devices support multi-link operation (MLO), including support for a lower band (e.g., sub-7 GHz band) as well as support for a mmWave band. As used herein, a mmWave band refers to a frequency band comprising one or more (e.g., license-exempt) bands above 30 GHz. MLO operation support may bring various benefits including, the ability to perform various exchanges in the lower-band (e.g., discovery/association, negotiation/scheduling (e.g., Target Wake Time (TWT) negotiation/scheduling), broadcast exchanges, beamforming training scheduling and feedback transmission, etc.) as well as the ability to provide a seamless and fast fallback to the lower band in the event of failure of the mmWave band.

An omnidirectional transmission pattern is generally used for transmitting RTS/CTS frames in lower bands. In the mmWave, an omnidirectional transmission pattern is not achievable due to the radio wave properties at these frequencies. Instead, a quasi-omnidirectional pattern (q-omni) which refers to the antenna pattern with the widest achievable beamwidth is used.

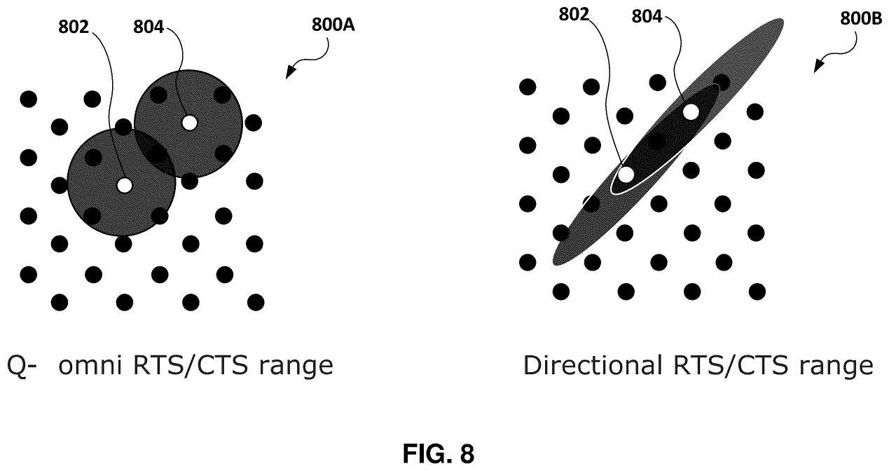

FIG. 8 illustrates examples of transmission of RTS/CTS frames in the mmWave band. In example 800A, a first STA 802 and a second STA 804 may exchange RTS and CTS frames by using a q-omni transmission pattern. In the mmWave band, however, q-omni transmission may result in a very short range as shown in FIG. 8. For example, the RTS/CTS transmission range may not reach the target STA of the transmission. In addition, the RTS/CTS transmission range may not cover many neighboring STAs, which thus remain as hidden nodes with respect to the subsequent data transmission setup by the RTS/CTS exchange.

In example 800B, first STA 802 and second STA 804 may exchange the RTS/CTS frames by using a directional beam transmission pattern. As shown in FIG. 8, the use of a directional beam transmission pattern increases the range of the RTS/CTS frames in the direction of the beam formed by the transmission pattern. This may allow the RTS/CTS frame to reach the target STA more easily. However, the directionality of the beam may degrade the hidden node problem as the RTS/CTS frame may reach even less of the neighboring STAs than using a q-omni transmission pattern.

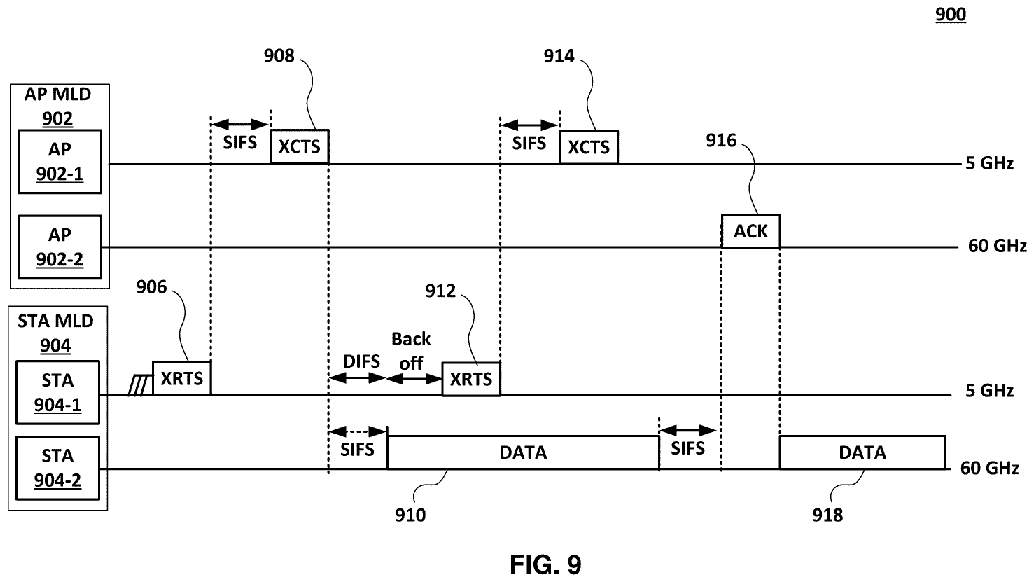

FIG. 9 is an example 900 that illustrates an existing cross-link reservation procedure for the mmWave band. As shown in FIG. 9, example 900 includes an AP MLD 902 and a STA MLD 904. AP MLD 902 may include APs 902-1 and 902-1. STA MLD 904 may include STAs 904-1 and 904-2. AP MLD 902 and STA MLD 904 both support MLO on a 5 GHZ (sub-7 GHz band) and a 60 GHz band (mmWave band). That is, AP MLD 902 and STA MLD 904 may exchange (transmit/receive) simultaneously using both a 5 GHz link (link in the 5 GHz band) and a 60 GHz link (link in the 60 GHz band).

In example 900, STA MLD 904 may transmit, via STA 904-1, a cross-link RTS (XRTS) frame 906 on the 5 GHz link to AP MLD 902 to reserve the 60 GHz link for a data transmission. As used herein, an XRTS frame refers to an RTS frame that is transmitted on a first link (e.g., 5 GHz link) requesting to reserve a second link (e.g., 60 GHz link) for a data transmission. AP MLD 902 may receive XRTS frame 906 on the 5 GHz link via AP 902-1. AP MLD 902 may respond to XRTS frame 906 by transmitting a cross-link CTS (XCTS) frame 908, via AP 902-1, on the 5 GHz link. As used herein, an XCTS frame refers to a CTS frame that is transmitted on a first link (e.g., 5 GHz link) accepting a reservation request of a second link (e.g., 60 GHz link) for a data transmission.

On receiving XCTS frame 908 via STA 904-1 on the 5 GHz link, STA MLD 904 may wait for a SIFS before starting to transmit a data frame 910 on the 60 GHz link via STA 904-2. In parallel (or before or after), STA MLD 904 may wait for a DIFS (DCF interframe spacing) and a random backoff before transmitting a further XRTS frame 912 on the 5 GHz link to reserve the 60 GHz link for a subsequent data transmission. The subsequent data transmission may be configured to start after data frame 910 is acknowledged by AP MLD 902. AP MLD 902 may respond to XRTS frame 912 by transmitting a XCTS frame 914 on the 5 GHz link.

When AP MLD 902 fully receives data frame 910 on the 60 GHz link, AP MLD 902 may wait for a SIFS before transmitting an ACK frame 916 on the 60 GHz link. STA MLD 904 may begin transmitting a data frame 918 on the 60 GHz link after receiving ACK frame 916. A SIFS wait between ACK frame 916 and data frame 918 may not be needed.

In example 900, XRTS frames 906 and 912 and XCTS frames 908 and 914 may be transmitted using an omnidirectional transmission pattern. On the 5 GHz link, the omnidirectional transmission pattern results in a relatively wide transmission range, which reduces the hidden node problem described above with reference to FIG. 8.

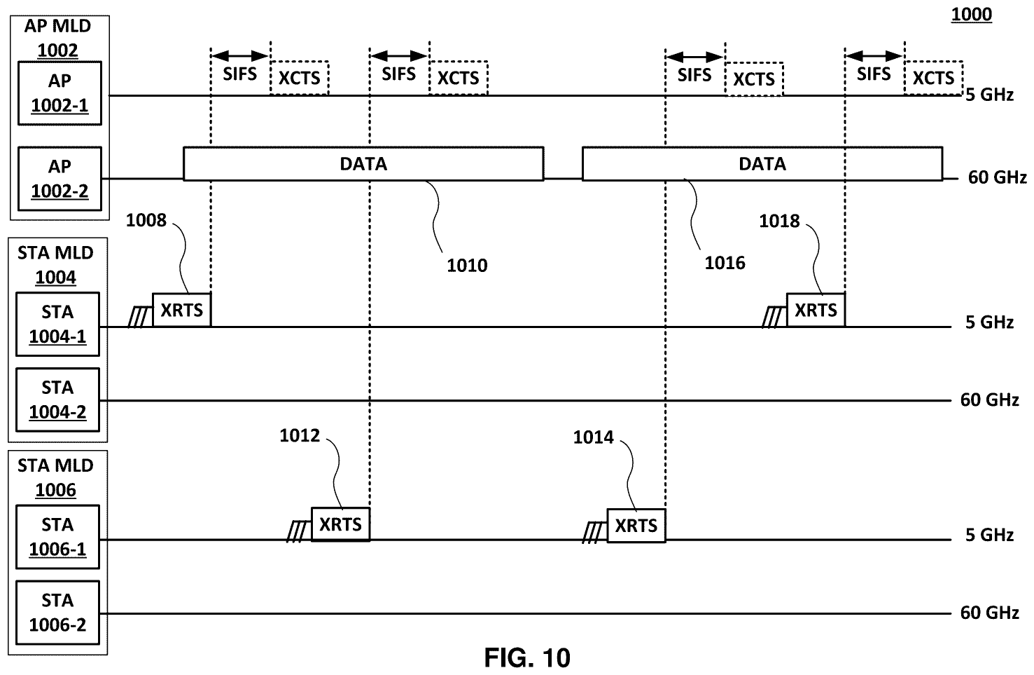

FIG. 10 is an example 1000 that illustrates a potential problem that may occur using the existing procedure described in FIG. 9. As shown in FIG. 10, example 1000 includes an AP MLD 1002, a STA MLD 1004, and a STA MLD 1006. AP MLD 1002 may include APs 1002-1 and 1002-1; STA MLD 1004 may include STAs 1004-1 and 1004-2; and STA MLD 1006 may include STAs 1006-1 and 1006-2. AP MLD 1002, STA MLD 1004, and STA MLD 1006 each support MLO on a 5 GHz and a 60 GHz band. That is, AP MLD 1002, STA MLD 1002, and STA MLD 1004 may exchange (transmit/receive) simultaneously using both a 5 GHz link (link in the 5 GHz band) and a 60 GHz link (link in the 60 GHz band).

In example 1000, STA MLD 1004 may transmit, via STA 1004-1, an XRTS frame 1008 on the 5 GHz link to AP MLD 1002 to reserve the 60 GHz link for a data transmission. AP MLD 1002 may receive XRTS frame 1008 on the 5 GHz link via AP 1002-1. According to the existing procedure described in FIG. 9, AP MLD 1002 shall respond to XRTS frame 1008 with an XCTS frame on the 5 GHz link, a SIFS after receiving XRTS frame 1008. However, in example 1000, reservation of the 60 GHz link may not be possible when AP receives XRTS frame 1008 due to the 60 GHz link being occupied by an ongoing transmission of a data frame 1010. Data frame 1010 may be transmitted by AP MLD 1002 or another STA MLD. AP MLD 1002 thus may not respond to XRTS frame 1008 from STA MLD 1004. Similarly, and for the same reason, AP MLD 1002 may not respond to an XRTS frame 1012 transmitted by STA MLD 1006 on the 5 GHz link and received by AP MLD 1002 during the transmission of data frame 1010.

STA MLDs 1004 and 1006 may repeat their reservation requests of the 60 GHz link by transmitting respectively XRTS frames 1014 and 1018 to AP MLD 1002. In example 1000, however, AP MLD 1002 may again not be able to respond to XRTS frames 1014 and 1018 due to an ongoing transmission of a data frame 1016 on the 60 GHz link. Data frame 1016 may be transmitted by AP MLD 1002 or another STA MLD.

Thus, according to the existing procedure, a STA MLD may continue to transmit XRTS frames on the 5 GHz link until the STA MLD receives an XCTS frame from the AP MLD, granting access to the 60 GHz link. When the utilization of the 60 GHz link is high or moderately high, the STA MLD may have to transmit several XRTS frames before the AP is able to respond with an XCTS frame. With multiple STAs trying to reserve the 60 GHz link, the 5 GHz link can easily become flooded with XRTS frame transmissions, reducing the availability of the 5 GHz link for other cross-link exchanges as well as a fallback link for the 60 GHz link.

Embodiments of the present disclosure address the above-described problem by providing cross-link reservation mechanisms that reduce or eliminate successive XRTS frame transmissions by a STA MLD until successful reservation of the cross-link channel.

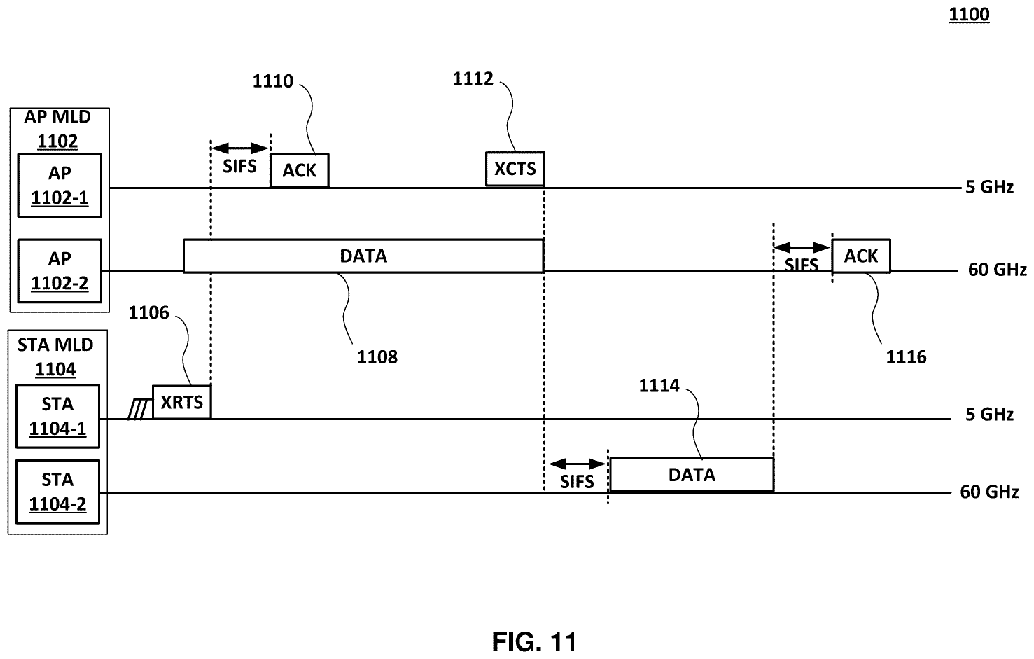

FIG. 11 is an example 1100 that illustrates a first procedure according to an embodiment. As shown in FIG. 11, example 1100 includes an AP MLD 1102 and a STA MLD 1104. AP MLD 1102 may include APs 1102-1 and 1102-1. STA MLD 1104 may include STAs 1104-1 and 1104-2. AP MLD 1102 and STA MLD 1104 both support MLO on a 5 GHz and a 60 GHz band. That is, AP MLD 1102 and STA MLD 1104 may exchange (transmit/receive) simultaneously using both a 5 GHz link (link in the 5 GHz band) and a 60 GHz link (link in the 60 GHz band).

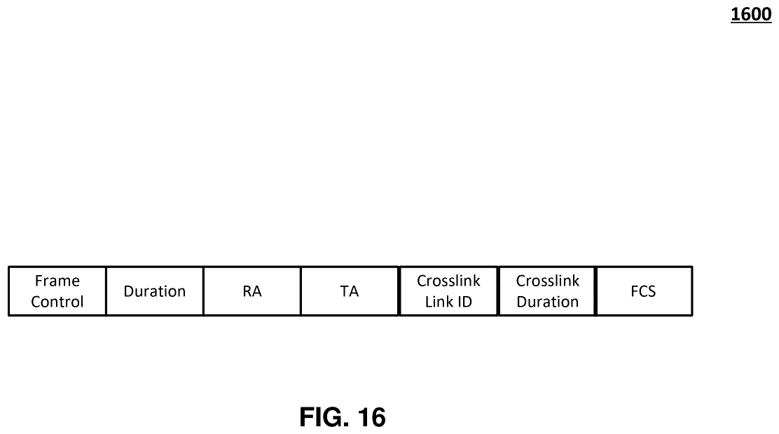

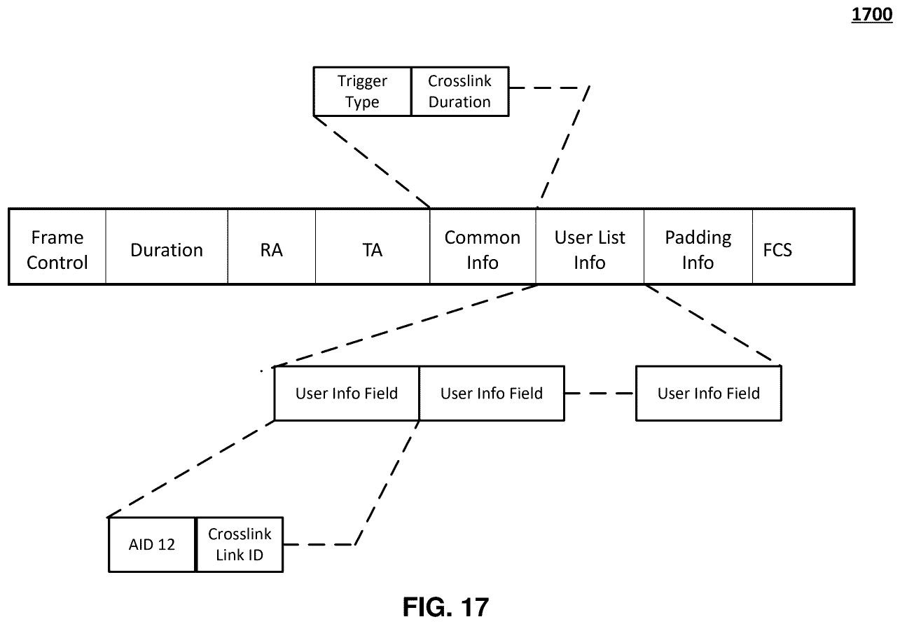

In example 1100, STA MLD 1104 may transmit, via STA 1104-1, an XRTS frame 1106 on the 5 GHz link to AP MLD 1102 to reserve the 60 GHz link for a data transmission. AP MLD 1102 may receive XRTS frame 1106 on the 5 GHz link via AP 1102-1. XRTS frame 1106 may have a frame format as illustrated in FIGS. 16 and 17 described further below.

Due to the 60 GHz link being occupied by an ongoing transmission of a data frame 1108, AP MLD 1102 may not respond to XRTS frame 1106 with an XCTS frame. Instead, in example 1100, AP MLD 1102 responds to XRTS frame 1106 with an acknowledgment (ACK) frame 1110. ACK frame 1110 may be transmitted a SIFS after receiving XRTS frame 1106 by AP MLD 1102. In an embodiment, in addition to acknowledging successful reception of XRTS frame 1106 by AP MLD 1102, ACK frame 1110 serves to instruct STA MLD 1104 to wait for an XCTS frame from AP MLD 1102. On receiving ACK frame 1110, STA MLD 1104 may refrain from transmitting a further XRTS frame as per the existing procedure. Instead, STA MLD 1104 may monitor the 5 GHz link for an XCTS frame from AP MLD 1102.

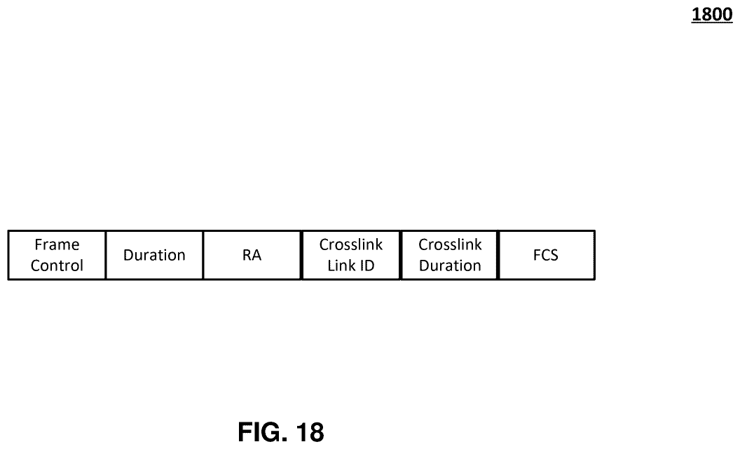

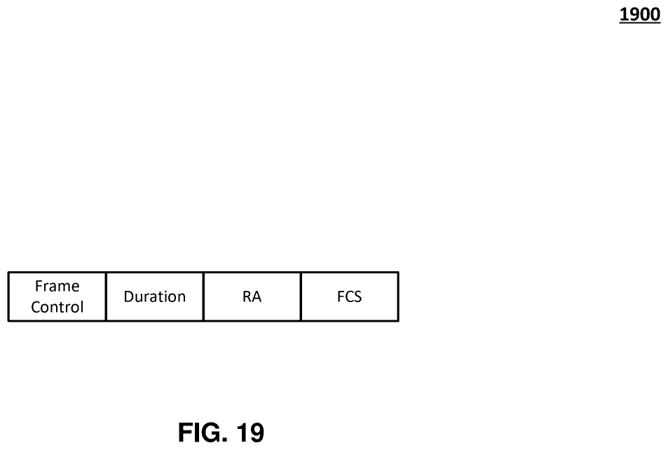

In example 1100, AP MLD 1102 may transmit an XCTS frame 1112 to STA MLD 1104 on the 5 GHz link near the end (or at the end) of the transmission of data frame 1108 on the 60 GHz link. XCTS frame 1112 may have a frame format as illustrated in FIGS. 18 and 19 described further below. On receiving XCTS frame 1112, STA MLD 1104 may proceed to transmit a data frame 1114 on the 60 GHz link. In an embodiment, XCTS frame 1112 may be transmitted such that its end of transmission on the 5 GHz link coincides with an end of transmission of data frame 1108 on the 60 GHz link. Data frame 1114 may be transmitted by STA MLD 1104 a SIFS from receiving XCTS frame 1112 (or, otherwise, a SIFS from the end of transmission of data frame 1108). AP MLD 1102 may acknowledge data frame 1114 by transmitting an ACK frame 1116 on the 60 GHz link.

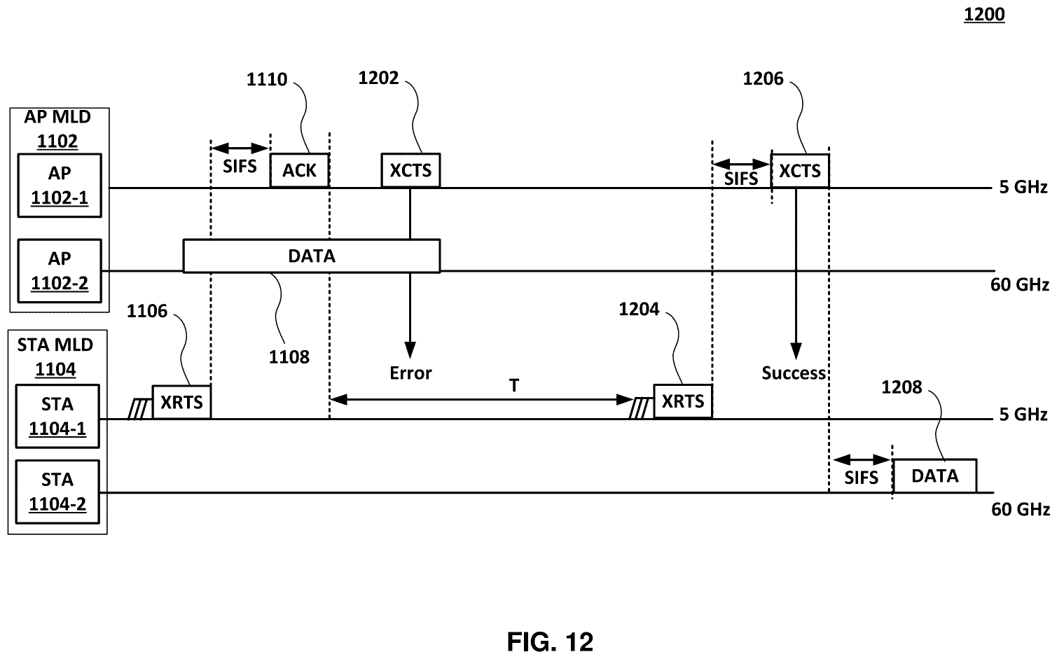

FIG. 12 is another example 1200 that illustrates the first procedure according to an embodiment. As shown in FIG. 12, example 1200 also include AP MLD 1102 and STA MLD 1104 described above with reference to example 1100. As in example 1100, STA MLD 1104 may transmit, via STA 1104-1, an XRTS frame 1106 on the 5 GHz link to AP MLD 1102 to reserve the 60 GHz link for a data transmission. AP MLD 1102 may receive XRTS frame 1106 on the 5 GHz link via AP 1102-1. XRTS frame 1106 may have a frame format as illustrated in FIGS. 16 and 17 described further below.

Due to the 60 GHz link being occupied by an ongoing transmission of a data frame 1108, AP MLD 1102 responds to XRTS frame 1106 with an ACK frame 1202. ACK frame 1202 may be transmitted a SIFS after receiving XRTS frame 1106 by AP MLD 1102. In an embodiment, in addition to acknowledging successful reception of XRTS frame 1106 by AP MLD 1102, ACK frame 1110 serves to instruct STA MLD 1104 to wait for an XCTS frame from AP MLD 1102. On receiving ACK frame 1110, STA MLD 1104 may refrain from transmitting a further XRTS frame as per the existing procedure. Instead, STA MLD 1104 may monitor the 5 GHz link for an XCTS frame from AP MLD 1102.

In example 1200, AP MLD 1102 may transmit an XCTS frame 1202 to STA MLD 1104 on the 5 GHZ link near the end (or at the end) of the transmission of data frame 1108 on the 60 GHz link. XCTS frame 1202 may have a frame format as illustrated in FIGS. 18 and 19 described further below. In example 1200, STA MLD 1104 may not receive or may receive XCTS frame 1202 in error.

In an embodiment, based on not receiving XCTS frame 1202 from AP MLD 1102, STA MLD 1104 may transmit a further XRTS frame 1204 on the 5 GHz link within a timeout duration (T) from receiving ACK frame 1110. STA MLD 1104 may use EDCA to transmit XRTS frame 1204. XRTS frame 1204 may have a frame format as illustrated in FIGS. 16 and 17 described further below. The 60 GHz link being available when AP MLD 1102 receives XRTS frame 1204, AP MLD 1102 may respond to XRTS frame 1204 with an XCTS frame 1206 on the 5 GHz link. XCTS frame 1206 may be transmitted a SIFS from AP MLD 1102 receiving XRTS frame 1204. XCTS frame 1206 may have a frame format as illustrated in FIGS. 18 and 19 described further below. On receiving XCTS frame 1206, STA MLD 1104 may proceed to transmit a data frame 1208 on the 60 GHz link. Data frame 1208 may be transmitted by STA MLD 1104 a SIFS from receiving XCTS frame 1206.

As illustrated in FIGS. 11 and 12, the first procedure according to embodiments may reduce the amount of XRTS frames transmitted by a STA MLD until the STA MLD receives an XCTS frame allowing data transmission on the 60 GHz link.

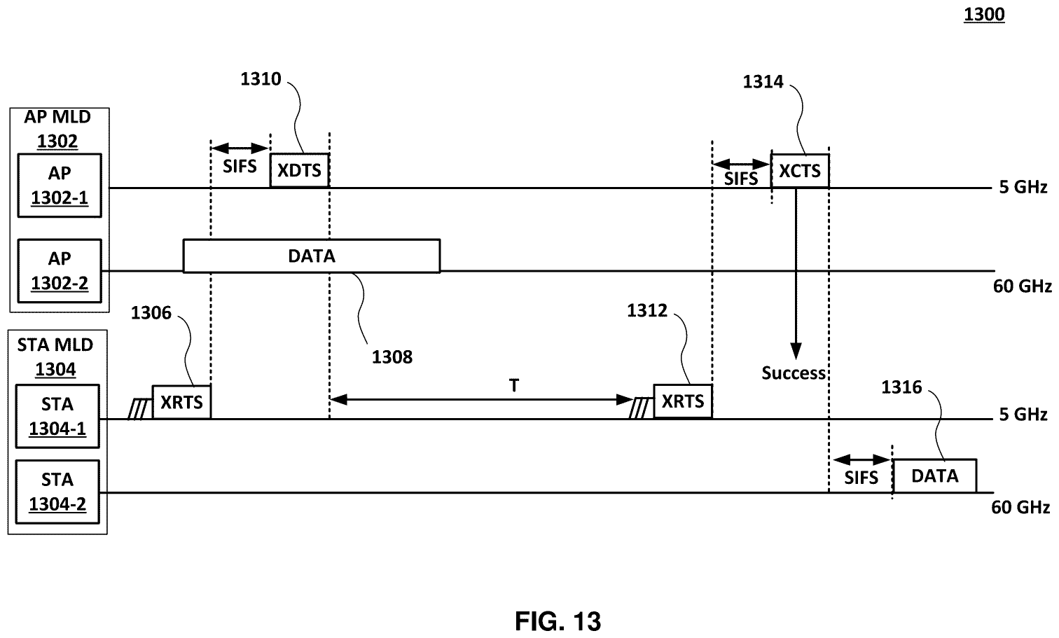

FIG. 13 is an example 1300 that illustrates a second procedure according to an embodiment. As shown in FIG. 13, example 1300 includes an AP MLD 1302 and a STA MLD 1304. AP MLD 1302 may include APs 1302-1 and 1302-1. STA MLD 1304 may include STAs 1304-1 and 1304-2. AP MLD 1302 and STA MLD 1304 both support MLO on a 5 GHz and a 60 GHz band. That is, AP MLD 1302 and STA MLD 1304 may exchange (transmit/receive) simultaneously using both a 5 GHz link (link in the 5 GHz band) and a 60 GHz link (link in the 60 GHz band).

In example 1300, STA MLD 1304 may transmit, via STA 1304-1, an XRTS frame 1306 on the 5 GHz link to AP MLD 1302 to reserve the 60 GHz link for a data transmission. AP MLD 1302 may receive XRTS frame 1306 on the 5 GHz link via AP 1302-1. XRTS frame 1306 may have a frame format as illustrated in FIGS. 16 and 17 described further below.

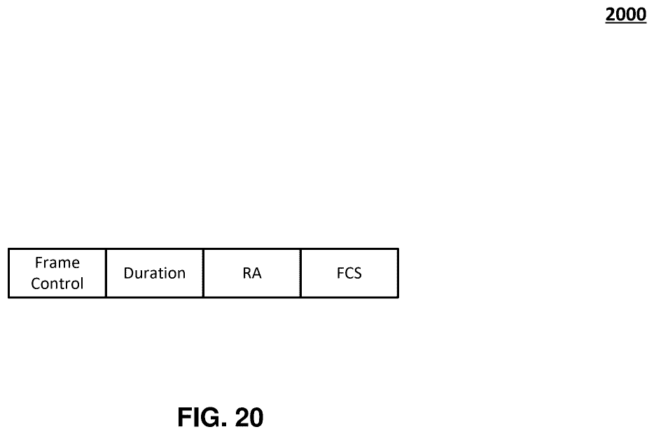

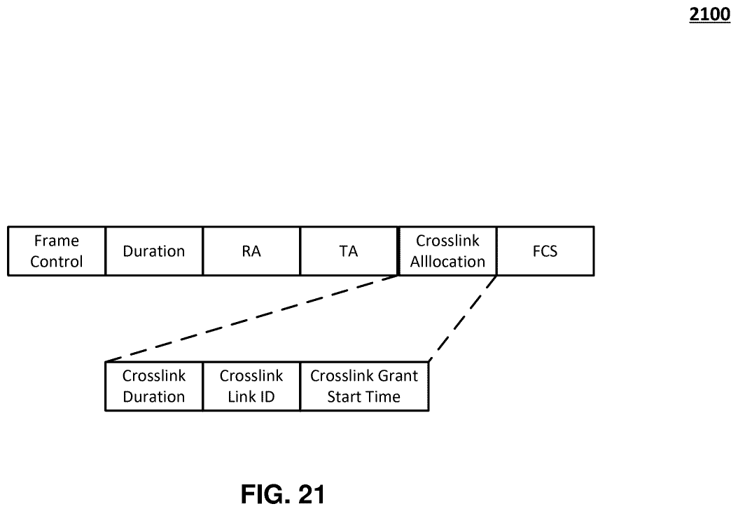

Due to the 60 GHz link being occupied by an ongoing transmission of a data frame 1308, AP MLD 1302 may not respond to XRTS frame 1306 with an XCTS frame. Instead, in example 1300, AP MLD 1302 responds to XRTS frame 1306 with a cross-link Denial to Send (XDTS) frame 1310. As used herein, an XDTS frame refers to a DTS frame that is transmitted on a first link (e.g., 5 GHz link) denying a request to transmit on a second link (e.g., 60 GHz link). XDTS frame 1310 may be transmitted a SIFS after receiving XRTS frame 1306 by AP MLD 1302. In an embodiment, XDTS frame 1310 may serve to acknowledge successful reception of XRTS frame 1306 by AP MLD 1302. In an embodiment, XDTS frame 1310 serves to instruct STA MLD 1304 that its request to transmit on the 60 GHz link is denied. XDTS frame 1310 may have a frame format as illustrated in FIGS. 20 and 21 described further below.

In an embodiment, on receiving XDTS frame 1310, STA MLD 1304 may refrain from transmitting a further XRTS frame until a pre-defined duration (T) has elapsed from the time of reception of XDTS frame 1310. Once the pre-defined duration T has elapsed, STA MLD 1304 may transmit a further XRTS frame 1312 on the 5 GHz link. STA MLD 1304 may use EDCA to transmit XRTS frame 1312. XRTS frame 1312 may have a frame format as illustrated in FIGS. 16 and 17 described further below. The 60 GHz link being available when AP MLD 1302 receives XRTS frame 1312, AP MLD 1302 may respond to XRTS frame 1312 with an XCTS frame 1314 on the 5 GHz link. XCTS frame 1314 may be transmitted a SIFS from AP MLD 1302 receiving XRTS frame 1312. XCTS frame 1316 may have a frame format as illustrated in FIGS. 18 and 19 described further below. On receiving XCTS frame 1316, STA MLD 1304 may proceed to transmit a data frame 1316 on the 60 GHz link. Data frame 1316 may be transmitted by STA MLD 1304 a SIFS from receiving XCTS frame 1314.

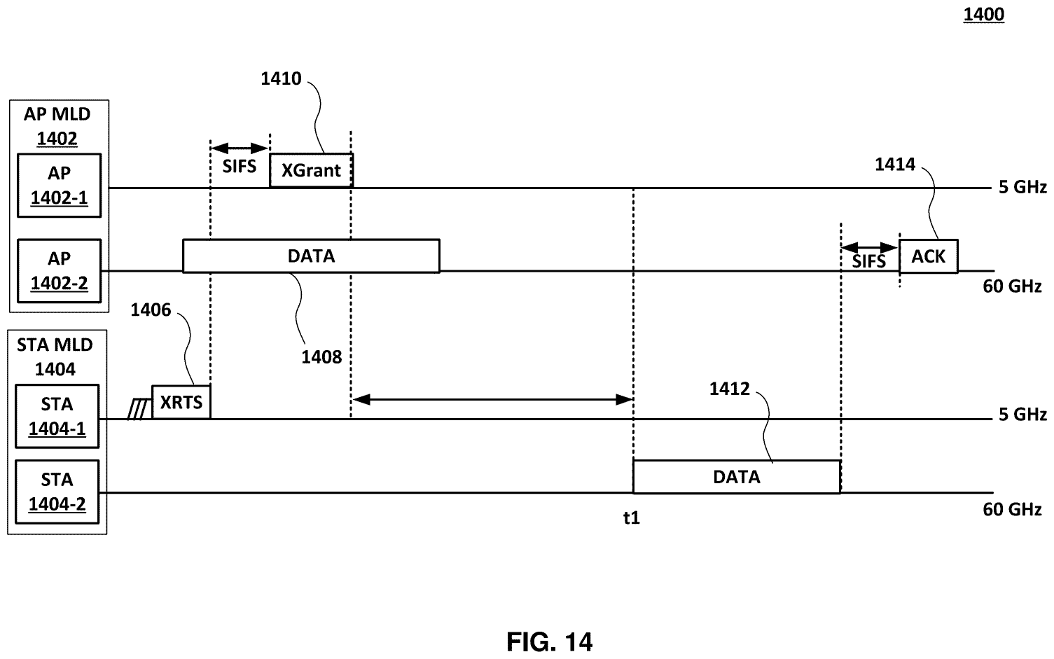

FIG. 14 is an example 1400 that illustrates a third procedure according to an embodiment. As shown in FIG. 14, example 1400 includes an AP MLD 1402 and a STA MLD 1404. AP MLD 1402 may include APs 1402-1 and 1402-1. STA MLD 1404 may include STAs 1404-1 and 1404-2. AP MLD 1402 and STA MLD 1404 both support MLO on a 5 GHz and a 60 GHz band. That is, AP MLD 1402 and STA MLD 1404 may exchange (transmit/receive) simultaneously using both a 5 GHz link (link in the 5 GHz band) and a 60 GHz link (link in the 60 GHz band).

In example 1400, STA MLD 1404 may transmit, via STA 1404-1, an XRTS frame 1406 on the 5 GHZ link to AP MLD 1402 to reserve the 60 GHz link for a data transmission. AP MLD 1402 may receive XRTS frame 1406 on the 5 GHz link via AP 1402-1. XRTS frame 1406 may have a frame format as illustrated in FIGS. 16 and 17 described further below.

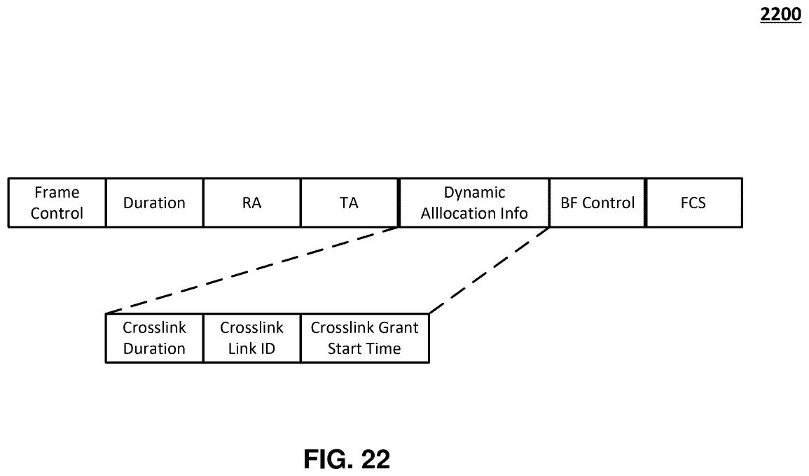

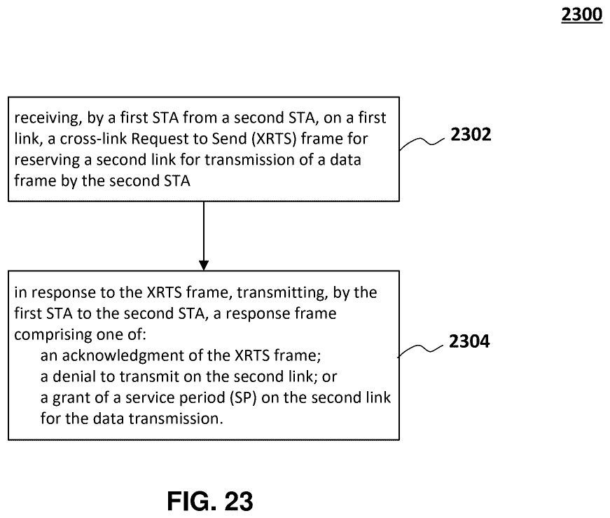

Due to the 60 GHz link being occupied by an ongoing transmission of a data frame 1408, AP MLD 1402 may not respond to XRTS frame 1406 with an XCTS frame. Instead, in example 1400, AP MLD 1402 responds to XRTS frame 1406 with a cross-link grant (XGrant) frame 1410. As used herein, an XGrant frame refers to a grant frame that is transmitted on a first link (e.g., 5 GHz link) granting/allocating a resource (e.g., time/spatial resource) on a second link (e.g., 60 GHz link). XGrant frame 1410 may be transmitted a SIFS after receiving XRTS frame 1406 by AP MLD 1402. In an embodiment, XGrant frame 1410 may serve to acknowledge successful reception of XRTS frame 1406 by AP MLD 1402. In an embodiment, XGrant frame 1410 serves to inform STA MLD 1404 of a service period (SP) allocated for uplink transmission by STA MLD 1404 on the 60 GHZ. In an embodiment, XGrant frame 1410 may indicate a start time (e.g., t1) and/or a duration of the SP. XGrant frame 1410 may have a frame format as illustrated in FIGS. 22 and 23 described further below.

In an embodiment, on receiving XGrant frame 1410, STA MLD 1404 refrains from transmitting any further XRTS frames for the data transmission and waits for the start time of the SP allocated to it in XGrant frame 1410. At the start time of the SP, STA MLD 1404 begins the transmission of a data frame 1412 on the 60 GHz link. AP MLD 1402 may acknowledge data frame 1412 by transmitting an ACK frame 1414 on the 60 GHz link, e.g., a SIFS after receiving data frame 1412.

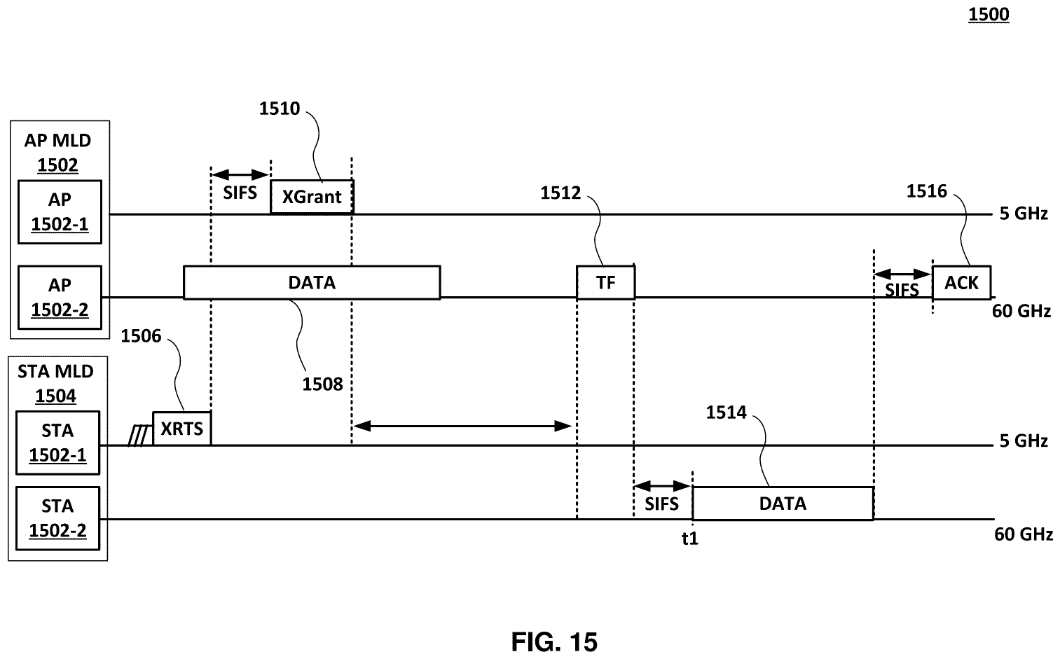

FIG. 15 is an example 1500 that illustrates a fourth procedure according to an embodiment. As shown in FIG. 15, example 1500 includes an AP MLD 1502 and a STA MLD 1504. AP MLD 1502 may include APs 1502-1 and 1502-1. STA MLD 1504 may include STAs 1504-1 and 1504-2. AP MLD 1502 and STA MLD 1504 both support MLO on a 5 GHz and a 60 GHz band. That is, AP MLD 1502 and STA MLD 1504 may exchange (transmit/receive) simultaneously using both a 5 GHz link (link in the 5 GHz band) and a 60 GHz link (link in the 60 GHz band).

In example 1500, STA MLD 1504 may transmit, via STA 1504-1, an XRTS frame 1506 on the 5 GHz link to AP MLD 1502 to reserve the 60 GHz link for a data transmission. AP MLD 1502 may receive XRTS frame 1506 on the 5 GHz link via AP 1502-1. XRTS frame 1506 may have a frame format as illustrated in FIGS. 16 and 17 described further below.

Due to the 60 GHz link being occupied by an ongoing transmission of a data frame 1508, AP MLD 1502 may not respond to XRTS frame 1506 with an XCTS frame. Instead, in example 1500, AP MLD 1502 responds to XRTS frame 1506 with an XGrant frame 1510. XGrant frame 1510 may be transmitted a SIFS after receiving XRTS frame 1506 by AP MLD 1502. In an embodiment, XGrant frame 1510 may serve to acknowledge successful reception of XRTS frame 1506 by AP MLD 1502. In an embodiment, XGrant frame 1510 serves to inform STA MLD 1504 of a trigger-enabled (TE) SP allocated for uplink transmission by STA MLD 1504 on the 60 GHz. In an embodiment, XGrant frame 1510 may indicate a start time (e.g., t1) and/or a duration of the TE SP. In another embodiment, XGrant frame 1510 may not indicate the start time of the TE SP. XGrant frame 1510 may have a frame format as illustrated in FIGS. 22 and 23 described further below.

In an embodiment, on receiving XGrant frame 1510, STA MLD 1504 refrains from transmitting any further XRTS frames for the data transmission and waits for a trigger frame from AP MLD 1502 on the 60 GHz link to transmit on the 60 GHz link. Before the start time of the SP, AP MLD 1502 transmits a trigger frame 1512 to STA MLD 1504 on the 60 GHz link. Trigger frame 1512 triggers STA MLD 1504 to start its data transmission on the 60 GHz link. In an embodiment, AP MLD 1502 transmits trigger frame 1512 a SIFS before the start time of the SP. In response to trigger frame 1512, STA MLD 1504 begins transmitting a data frame 1514 a SIFS after receiving trigger frame 1512. As such, the start of transmission of data frame 1514 coincides with the start time of the SP. AP MLD 1502 may acknowledge data frame 1514 by transmitting an ACK frame 1516 on the 60 GHz link, e.g., a SIFS after receiving data frame 1514.

FIG. 16 illustrates an example control frame 1600 which may be used as an XRTS frame according to an embodiment. Control frame 1600 may be an embodiment of XRTS frame 1106, 1306, 1406, or 1506. As shown in FIG. 16, control frame 1600 may include a Frame Control field, a Duration field, an RA field, a TA field, a Crosslink Link ID field, a Crosslink Duration field, and an FCS field. The Frame Control, Duration, RA, TA, and FCS fields may be similar to corresponding fields described above with reference to FIG. 3.

The Crosslink Link ID field indicates an identifier of the cross-link sought to be reserved for a data transmission by the XRTS frame. For example, if the XRTS frame is transmitted over a 5 GHz link, the Crosslink Link ID field may indicate an identifier of a 60 GHz link sought to be reserved by the XRTS frame. The Crosslink Duration field indicates a duration (e.g., a requested duration) for which the cross-link is sought to be or being reserved for the data transmission.

FIG. 17 illustrates an example trigger frame 1700 which may be used as an XRTS frame according to an embodiment. Trigger frame 1700 may be an embodiment of XRTS frame 1106, 1306, 1406, or 1506. As shown in FIG. 17, trigger frame 1700 may include a Frame Control field, a Duration field, an RA field, a TA field, a Common Info field, a User List Info field, a Padding Info field, and an FCS field. The Frame Control, Duration, RA, TA, Padding Info, and FCS fields may be similar to corresponding fields described above with reference to trigger frame 300 of FIG. 3.

The Common Info field may be a modified version of the Common Info field of trigger frame 300 described in FIG. 3 or of Common Info field 400 described in FIG. 4. In an embodiment, the Common Info field may include similar fields as Common Info field 400. In addition, the Common Info field may include a Crosslink Duration field instead of a UL Length subfield as shown in Common Info field 400.

In an embodiment, the value of a Trigger Type subfield of the Common Info field may be used to indicate that trigger frame 1700 is an XRTS frame (rather than a trigger frame). The Crosslink Duration field indicates a duration (e.g., a requested duration) for which the cross-link is sought to be or being reserved for the data transmission.

The User List Info field may be a modified version of the User List Info field of trigger frame 300 described in FIG. 3. In an embodiment, like the User List Info field of trigger frame 300, the User List Info field includes a plurality of User Info fields. In an embodiment, a first of the plurality of User Info fields may be adapted to carry a Crosslink Link ID subfield that indicates an identifier of the cross-link sought to be reserved for a data transmission by the XRTS frame. In an embodiment, an AID12 subfield of the first User Info Field may be set to a special value to be identified as such by a receiving AP. The second and subsequent User Info fields may be used by an XDRTS transmitting STA to reserve a second or a third mmWave channel with distinct Crosslink Link IDs from the receiving AP.

FIG. 18 illustrates an example control frame 1800 which may be used as an XCTS frame according to an embodiment. Control frame 1800 may be an embodiment of XCTS frame 1112, 1202, 1206, or 1314. As shown in FIG. 18, control frame 1800 may include a Frame Control field, a Duration field, an RA field, a Crosslink Link ID field, a Crosslink Duration field, and an FCS field. The Frame Control, Duration, RA, and FCS fields may be similar to corresponding fields described above with reference to FIG. 3.

Control frame 1800 may be transmitted as an XCTS frame in response to an XRTS frame. The Crosslink Link ID field indicates an identifier of the cross-link sought to be reserved for a data transmission by the XRTS frame. For example, if the XRTS frame is transmitted over a 5 GHz link, the Crosslink Link ID field may indicate an identifier of a 60 GHz link sought to be reserved by the XRTS frame. The Crosslink Duration field indicates a duration (e.g., a requested duration) for which the cross-link is sought to be or is being reserved for the data transmission by the XRTS frame.

FIG. 19 illustrates an example CTS frame 1900 which may be used as an XCTS frame according to an embodiment. CTS frame 1900 may be an embodiment of XCTS frame 1112, 1202, 1206, or 1314. As shown in FIG. 19, CTS frame 1900 may include a Frame Control field, a Duration field, an RA field, and an FCS field. In an embodiment, the Frame Control, RA, and FCS fields of CTS frame 1900 may be similar to corresponding fields of an existing CTS frame as defined in section 9.3.1.3 of the IEEE 802.11 standard (“IEEE P802.11-REVme/D2.0, October 2022”).

As CTS frame 1900 may be transmitted on a first link to reserve a second link for a data transmission, the Duration field of CTS frame 1900 may indicate the duration of CTS frame 1900. This may be different than in existing CTS frames where the Duration field indicates the duration of the data transmission (up to the ACK frame) being protected.

In an embodiment, CTS frame 1900 may be identified as an XCTS frame, instead of a regular CTS frame, based on being transmitted a SIFS after an XRTS frame.

FIG. 20 illustrates an example control frame 2000 which may be used as an XDTS frame according to an embodiment. Control frame 2000 may be an embodiment of XDTS frame 1310. As shown in FIG. 20, control frame 2000 may include a Frame Control field, a Duration field, an RA field, and an FCS field. The Frame Control, Duration, RA, and FCS fields may be similar to corresponding fields described above with reference to FIG. 3.

Control frame 2000 may be transmitted as an XDTS frame in response to an XRTS frame. In an embodiment, the Frame Control field may indicate that control frame 2000 is an XDTS frame. The Duration field may indicate the duration of control frame 2000. The RA field may indicate the address of the STA that transmitted the XRTS frame.

In an embodiment, DMG DTS frame 600 may be identified as an XDTS frame when transmitted using a UHR PPDU and as a regular DMG DTS frame when transmitted using a PPDU in accordance with the IEEE 802.11ad/ay standard amendment.

FIG. 21 illustrates an example control frame 2100 which may be used as an XGrant frame according to an embodiment. Control frame 2100 may be an embodiment of XGrant frame 1410 or 1510. As shown in FIG. 21, control frame 2100 may include a Frame Control field, a Duration field, an RA field, a Crosslink Allocation field, and an FCS field. The Frame Control, Duration, RA, TA, and FCS fields may be similar to corresponding fields described above with reference to FIG. 5. The Crosslink Allocation field may include a Crosslink Duration, a Crosslink Link ID, and a Crosslink Grant Start Time subfield.

Control frame 2100 may be transmitted as an XGrant frame in response to an XRTS frame to allocate a service period (SP) to the STA transmitting the XRTS frame on the cross-link. The Crosslink Duration may indicate a duration of the SP granted on the cross-link in response to the XRTS frame. The Crosslink Link ID field indicates an identifier of the cross-link on which the SP is being allocated. For example, if the XRTS frame is transmitted over a 5 GHz link, the Crosslink Link ID field may indicate an identifier of a 60 GHz on which the SP is granted. The Crosslink Grant Start Time indicates a start time of the SP granted on the cross-link.

FIG. 22 illustrates an example DMG grant frame 2200 which may be used as an XGrant frame according to an embodiment. DMG grant frame 2200 may be an embodiment of XGrant frame 1410 or 1510. DMG grant frame 2200 may be a modified version of DMG grant frame 500 described above. As shown in FIG. 22, DMG grant frame 2200 may include a Frame Control field, a Duration field, an RA field, a TA field, a Dynamic Allocation Info field, a BF Control field, and an FCS field. The Frame Control, Duration, RA, TA, BF Control, and FCS fields may be similar to corresponding fields of frame 500 described above. In an embodiment, the Dynamic Allocation Info field may be modified to include a Crosslink Duration, a Crosslink Link ID, and a Crosslink Grant Start Time subfield.

DMG grant frame 2200 may be transmitted as an XGrant frame in response to an XRTS frame to allocate an SP to the STA transmitting the XRTS frame on the cross-link. The Crosslink Duration may indicate a duration of the SP granted on the cross-link in response to the XRTS frame. The Crosslink Link ID field indicates an identifier of the cross-link on which the SP is being allocated. For example, if the XRTS frame is transmitted over a 5 GHz link, the Crosslink Link ID field may indicate an identifier of a 60 GHz on which the SP is granted. The Crosslink Grant Start Time indicates a start time of the SP granted on the cross-link.

In an embodiment, DMG grant frame 2200 may be identified as an XGrant frame when transmitted using a UHR PPDU and as a regular DMG Grant frame when transmitted using a PPDU in accordance with the IEEE 802.11ad/ay standard amendment.

FIG. 23 illustrates an example process 2300 according to an embodiment. Example process 2300 is provided for the purpose of illustration only and is not limiting of embodiments. Example process 2300 may be performed by a first STA (e.g., STA or AP). As shown in FIG. 23, process 2300 includes steps 2302 and 2304.

In step 2302, process 2300 may include receiving, from a second STA, on a first link, an XRTS frame for reserving a second link for transmission of a data frame by the second STA. The second STA may be a STA or an AP. In an embodiment, the first link may be a sub-7 GHz link and the second link may be a mmWave link, or vice versa.

In an embodiment, the XRTS frame comprises a control frame or a trigger frame. For example, the XRTS frame may have a format as illustrated in FIGS. 16 and 17 described above. In an embodiment, the XRTS frame comprises an identifier of the second link. In an embodiment, the XRTS frame comprises a duration (e.g., a requested duration) for the second STA to transmit the data frame on the second link.

Step 2304 may include transmitting, to the second STA, a response frame in response to the XRTS frame. The response frame may include: an acknowledgment of the XRTS frame; a denial to transmit on the second link; or a grant of a service period (SP) on the second link for the data transmission.

In an embodiment, transmitting the response frame comprises transmitting the response frame based on the second link being unavailable for transmission of the data frame by the second STA. The second link may be unavailable due to an ongoing transmission on the second link. The ongoing transmission on the second link may be by the first STA, or by a third STA to the first STA or to a fourth STA.

In an embodiment, the response frame comprises the acknowledgment of the XRTS frame. The acknowledgment of the XRTS frame may comprise an ACK frame. In such an embodiment, process 2300 may further comprise transmitting an XCTS frame to the second STA. The XCTS frame may be transmitted after transmitting the response frame. In an embodiment, the XCTS frame may be transmitted more than a SIFS from receiving the XRTS frame from the second STA. In an embodiment, the XCTS frame comprises a control frame or a CTS frame. For example, the XCTS frame may have a format as illustrated in FIGS. 18 and 19 described above. In an embodiment, the XCTS frame comprises an identifier of the second link. In an embodiment, where the XCTS frame comprises the control frame, the control frame comprises a duration (e.g., a requested duration) for the second STA to transmit the data frame on the second link. In an embodiment, process 2300 may further comprise receiving the data frame from the second STA in response to the XCTS frame. The data frame may be received a SIFS after transmitting the XCTS frame.

In another embodiment, the response frame comprises the denial to transmit on the second link. In such an embodiment, the response frame acknowledges successful reception of the XRTS by the first STA. In an embodiment, the response frame may be an XDTS frame. The XDTS frame may comprise a control frame or a DMG DTS frame. For example, the XDTS frame may have a format as illustrated in FIG. 20 described above. In an embodiment, process 2300 may further comprise receiving, on the first link, a further XRTS frame from the second STA for reserving the second link for transmission of the data frame by the second STA; and transmitting, on the first link, an XCTS frame to the second STA in response to the further XRTS frame. In an embodiment, process 2300 may further comprise receiving the data frame from the second STA in response to the XCTS frame. The data frame may be received a SIFS after transmitting the XCTS frame.

In a further embodiment, the response frame comprises the grant of the SP on the second link for transmission of the data frame. In an embodiment, the response frame comprises an XGrant frame. The XGrant frame may comprise a control frame or a DMG grant frame. For example, the XGrant frame may have a format as illustrated in FIGS. 21 and 22 described above. In an embodiment, the XGrant frame comprises an identifier of the second link, a duration of the SP, and/or a start time of the SP. In an embodiment, process 2300 may further comprise receiving the data frame from the second STA during the SP on the second link.

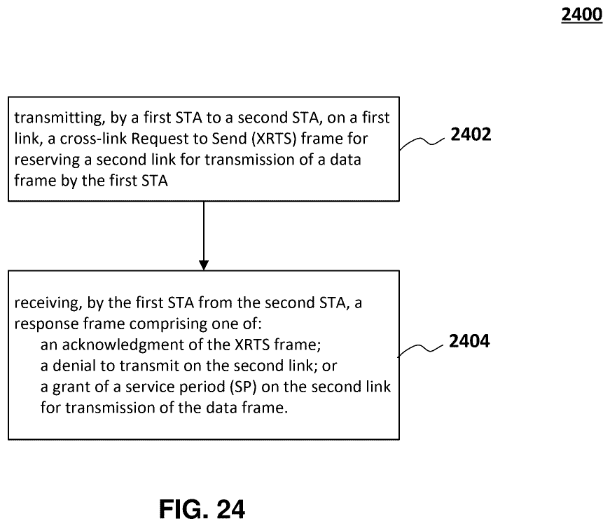

FIG. 24 illustrates another example process 2400 according to an embodiment. Example process 2400 is provided for the purpose of illustration only and is not limiting of embodiments. Example process 2400 may be performed by a first STA (e.g., STA or AP). As shown in FIG. 24, process 2400 includes steps 2402 and 2404.

In step 2402, process 2400 may include transmitting, to a second STA, on a first link, an XRTS frame for reserving a second link for transmission of a data frame by the first STA. The second STA may be a STA or an AP. In an embodiment, the first link may be a sub-7 GHz link and the second link may be a mmWave link, or vice versa.

In an embodiment, the XRTS frame comprises a control frame or a trigger frame. For example, the XRTS frame may have a format as illustrated in FIGS. 16 and 17 described above. In an embodiment, the XRTS frame comprises an identifier of the second link. In an embodiment, the XRTS frame comprises a duration (e.g., a requested duration) for the first STA to transmit the data frame on the second link.

Step 2404 may include receiving, from the second STA, a response frame in response to the XRTS frame. The response frame may include: an acknowledgment of the XRTS frame; a denial to transmit on the second link; or a grant of a service period (SP) on the second link for the data transmission.

In an embodiment, the response frame is transmitted based on the second link being unavailable for transmission of the data frame by the first STA. The second link may be unavailable due to an ongoing transmission on the second link. The ongoing transmission on the second link may be by the second STA, or by a third STA to the second STA or to a fourth STA.

In an embodiment, the response frame comprises the acknowledgment of the XRTS frame. The acknowledgment of the XRTS frame may comprise an ACK frame. In such an embodiment, process 2400 may further comprise receiving an XCTS frame from the second STA. The XCTS frame may be received after receiving the response frame. In an embodiment, the XCTS frame may be received more than a SIFS from transmitting the XRTS frame to the second STA. In an embodiment, the XCTS frame comprises a control frame or a CTS frame. For example, the XCTS frame may have a format as illustrated in FIGS. 18 and 19 described above. In an embodiment, the XCTS frame comprises an identifier of the second link. In an embodiment, where the XCTS frame comprises the control frame, the control frame comprises a duration (e.g., a requested duration) for the first STA to transmit the data frame on the second link. In an embodiment, process 2400 may further comprise transmitting the data frame to the second STA in response to the XCTS frame. The data frame may be transmitted a SIFS after receiving the XCTS frame. In an embodiment, process 2400 may further comprise transmitting a further XRTS frame based on not receiving an XCTS frame from the second STA within a timeout duration from receiving the acknowledgment of the XRTS frame.

In another embodiment, the response frame comprises the denial to transmit on the second link. In such an embodiment, the response frame acknowledges successful reception of the XRTS by the second STA. In an embodiment, the response frame may be an XDTS frame. The XDTS frame may comprise a control frame or a DMG DTS frame. For example, the XDTS frame may have a format as illustrated in FIG. 20 described above. In an embodiment, process 2400 may further comprise transmitting, on the first link, a further XRTS frame to the second STA for reserving the second link for transmission of the data frame by the first STA; and receiving, on the first link, an XCTS frame from the second STA in response to the further XRTS frame. In an embodiment, the further XRTS frame may be transmitted a pre-defined duration from receiving the response frame comprising the denial to transmit on the second link. In an embodiment, process 2400 may further comprise transmitting the data frame to the second STA in response to the XCTS frame. The data frame may be transmitted a SIFS after receiving the XCTS frame.

In a further embodiment, the response frame comprises the grant of the SP on the second link for transmission of the data frame. In an embodiment, the response frame comprises an XGrant frame. The XGrant frame may comprise a control frame or a DMG grant frame. For example, the XGrant frame may have a format as illustrated in FIGS. 21 and 22 described above. In an embodiment, the XGrant frame comprises an identifier of the second link, a duration of the SP, and/or a start time of the SP. In an embodiment, process 2400 may further comprise transmitting the data frame to the second STA during the SP on the second link.

What is claimed is:

1. A first station (STA) comprising:
one or more processors; and
memory storing instructions that, when executed by the one or more processors, cause the first STA to:
receive from a second STA, on a first link, a first frame for reserving a second link for transmission of a data frame by the second STA; and
in response to the first frame, transmit to the second STA a response frame comprising one of:
an acknowledgment of the first frame;
a denial to transmit on the second link; or
a grant of a service period (SP) on the second link for the data transmission.

2. The first STA of claim 1, wherein the first link is a sub-7 GHz link and the second link is a mmWave link.

3. The first STA of claim 1, wherein the first frame comprises an identifier of the second link.

4. The first STA of claim 1, wherein the response frame comprises the acknowledgment of the first frame, the response frame comprising an ACK frame.

5. The first STA of claim 4, wherein the instructions, when executed by the one or more processors, further cause the first STA to transmit a second frame to the second STA, wherein the second frame indicates that the first STA is ready to receive the data frame from the second STA on the second link.

6. The first STA of claim 5, wherein the instructions, when executed by the one or more processors, further cause the first STA to transmit the second frame more than a short interframe spacing (SIFS) from receiving the first frame.

7. The first STA of claim 1, wherein the response frame comprises the denial to transmit on the second link, the response frame comprising a second frame indicating that the second STA is not allowed to transmit the data frame on the second link.

8. The first STA of claim 1, wherein the response frame comprises the grant of the SP on the second link for transmission of the data frame, the response frame comprising a cross-link grant frame.

9. The first STA of claim 8, wherein the cross-link grant frame comprises a start time of the SP.

10. A first station (STA) comprising:
one or more processors; and
memory storing instructions that, when executed by the one or more processors, cause the first STA to:
transmit to a second STA, on a first link, a first frame for reserving a second link for transmission of a data frame by the first STA; and
receive from the second STA a response frame comprising one of:
an acknowledgment of the first frame;
a denial to transmit on the second link; or
a grant of a service period (SP) on the second link for the data transmission.

11. The first STA of claim 10, wherein the first link is a sub-7 GHz link and the second link is a mmWave link.

12. The first STA of claim 10, wherein the first frame comprises an identifier of the second link.

13. The first STA of claim 10, wherein the response frame comprises the acknowledgment of the first frame, the response frame comprising an ACK frame.

14. The first STA of claim 13, wherein the instructions, when executed by the one or more processors, further cause the first STA to receive a second frame from the second STA.

15. The first STA of claim 14, wherein the instructions, when executed by the one or more processors, further cause the first STA to receive the second frame more than a short interframe spacing (SIFS) from transmitting the first frame.

16. The first STA of claim 10, wherein the response frame comprises the denial to transmit on the second link, the response frame comprising a second frame indicating that the first STA is not allowed to transmit the data frame on the second link.

17. The first STA of claim 16, wherein the instructions, when executed by the one or more processors, further cause the first STA to:
receive, on the first link, a third frame from the second STA for reserving the second link for transmission of the data frame by the second STA; and
transmit, on the first link, a fourth frame to the second STA in response to the third frame.

18. The first STA of claim 10, wherein the response frame comprises the grant of the SP on the second link for transmission of the data frame, the response frame comprising a cross-link grant frame.

19. A non-transitory computer-readable medium comprising instructions that, when executed by one or more processors of a first station (STA), cause the first STA to:
receive from a second STA, on a first link, a first frame for reserving a second link for transmission of a data frame by the second STA; and
in response to the first frame, transmit to the second STA a response frame comprising one of:
an acknowledgment of the first frame;
a denial to transmit on the second link; or
a grant of a service period (SP) on the second link for the data transmission.

20. The non-transitory computer-readable medium of claim 19, wherein the first link is a sub-7 GHz link and the second link is a mmWave link.
